(19) United States
(12) Patent Application Publication
(10) Pub. No.: US 2026/0254560 A1
(43) Pub. Date: Aug. 27, 2026

(54) CODE RATES OF CONTROL MESSAGES BASED ON PRIORITY LEVEL

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US)

(21) Appl. No.: 19/065,303

(22) Filed: Feb. 27, 2025

(51) Int. Cl. H04L 1/00; H04B 7/06; H04L 1/1812; H04L 5/00; H04W 72/21

(52) U.S. Cl. CPC H04L 1/0057; H04B 7/0626; H04L 1/1812; H04L 5/0048; H04W 72/21

(57) ABSTRACT

Various aspects of the present disclosure generally relate to wireless communication. In some aspects, a wireless communication device may transmit a first code block (CB) of a transport block (TB), the first CB associated with a first code rate in accordance with the first CB including one or more first control messages of a first priority level. The wireless communication device may transmit a second CB of the TB, the second CB associated with a second code rate that is greater than the first code rate in accordance with the second CB including one or more second control messages of a second priority level that is lower than the first priority level. Numerous other aspects are described.

### FIELD OF THE DISCLOSURE

Aspects of the present disclosure generally relate to wireless communication and specifically relate to techniques, apparatuses, and methods associated with code rates of control messages in accordance with priority levels.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

An uplink or downlink transport block (TB) may carry one or more of data messages or control messages in a payload. For example, a TB may carry a medium access control (MAC) control element (MAC-CE) that includes layer 2 control information and is jointly encoded with a shared data channel, or one or more upper layer control messages (e.g., control messages above a physical (PHY) layer).

### SUMMARY

The systems, methods, and devices of this disclosure each have several innovative aspects, no single one of which is solely responsible for the desirable attributes disclosed herein.

Some aspects described herein relate to an apparatus for wireless communication. The apparatus may include one or more memories and one or more processors coupled to the one or more memories. The one or more processors may be individually or collectively configured to transmit a first code block (CB) of a transport block (TB), the first CB associated with a first code rate in accordance with the first CB including one or more first control messages of a first priority level. The one or more processors may be individually or collectively configured to transmit a second CB of the TB, the second CB associated with a second code rate that is greater than the first code rate in accordance with the second CB including one or more second control messages of a second priority level that is lower than the first priority level.

Some aspects described herein relate to a method of wireless communication performed by a wireless communication device. The method may include transmitting a first CB of a TB, the first CB associated with a first code rate in accordance with the first CB including one or more first control messages of a first priority level. The method may include transmitting a second CB of the TB, the second CB associated with a second code rate that is greater than the first code rate in accordance with the second CB including one or more second control messages of a second priority level that is lower than the first priority level.

Some aspects described herein relate to an apparatus for wireless communication. The apparatus may include means for transmitting a first CB of a TB, the first CB associated with a first code rate in accordance with the first CB including one or more first control messages of a first priority level. The apparatus may include means for transmitting a second CB of the TB, the second CB associated with a second code rate that is greater than the first code rate in accordance with the second CB including one or more second control messages of a second priority level that is lower than the first priority level.

Some aspects described herein relate to a non-transitory computer-readable medium storing a set of instructions for wireless communication. The set of instructions include one or more instructions that, when executed by one or more processors of a wireless communication device, cause the wireless communication device to transmit a first CB of a TB, the first CB associated with a first code rate in accordance with the first CB including one or more first control messages of a first priority level. The set of instructions include one or more instructions that, when executed by one or more processors of the wireless communication device, cause the wireless communication device to transmit a second CB of the TB, the second CB associated with a second code rate that is greater than the first code rate in accordance with the second CB including one or more second control messages of a second priority level that is lower than the first priority level.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example associated with signaling for code rates of control messages in accordance with priority levels.

FIG. 4 is a diagram illustrating an example associated with indicating that an uplink transport block includes at least one control message of a first priority level.

FIG. 5 is a diagram illustrating an example process performed, for example, at a wireless communication device or an apparatus of a wireless communication device.

FIG. 6 is a diagram of an example apparatus for wireless communication.

### DETAILED DESCRIPTION

Important control messages carried in an uplink transport block (TB) may include a radio link control (RLC) status report for a downlink, an indication of unsuccessful downlink hybrid automatic repeat request (HARQ) termination, or an uplink medium access control (MAC) control element (MAC-CE) (e.g., a beam failure recovery (BFR) MAC-CE, a buffer status report (BSR) MAC-CE, a power headroom report (PHR) MAC-CE, a configured grant (CG) confirmation MAC-CE, a listen-before-talk (LBT) failure MAC-CE, or the like), among other examples. Important control messages carried in a downlink TB may include an RLC status report for an uplink, an indication of unsuccessful uplink HARQ termination, or a downlink MAC-CE (e.g., a timing advance (TA) command MAC-CE, a transmission configuration indicator (TCI) state activation MAC-CE, a secondary cell (SCell) activation or deactivation MAC-CE, a discontinuous reception (DRX) command MAC-CE, or the like), among other examples.

In some examples, if a TB size (TBS) of a TB exceeds a threshold, then the TB may be segmented into code blocks (CBs). In some examples, multiple CBs may belong to a CB group (CBG). For example, acknowledgments, negative acknowledgments, or retransmission requests may be based on CBGs. A procedure for segmenting a TB into CBs may depend on whether the TB is a downlink TB or an uplink TB. On the downlink, a network node may place control message bits (e.g., downlink MAC-CE bits) at the beginning of the TB, insert shared channel (SCH) data after the control message bits, and introduce padding after the SCH data, which may help to ensure that the TB has an appropriate TBS. On the uplink, a user equipment (UE) may place SCH data at the beginning of the TB, insert control message bits (e.g., uplink MAC-CE bits) after the SCH data, and introduce padding after the control message bits, which may help to ensure that the TB has an appropriate TBS.

In some examples, important control message(s) carried by uplink or downlink TBs may not be decoded successfully. For example, decoding may fail due to poor channel conditions, interference, or the like. Failure to decode important control messages from an uplink or downlink TB may lead to excessive resource utilization, such as memory, processing, or resource utilization due to failed or unnecessary transmissions or retransmissions.

Additionally, or alternatively, a UE or a network node may be unaware of a presence of an important control message in a TB. For example, in cases where a network node is not aware of the presence of an important control message in an uplink TB, the network node may not schedule additional HARQ retransmission attempts for the uplink TB. As a result, the network node may be unable to successfully decode uplink TBs with important control messages.

Various aspects relate generally to improving transmission of important control messages. Some aspects more specifically relate to a dedicated CB that is designated for carrying important control messages. A code rate of the dedicated CB may be lower than code rates of other CBs in the same TB. For example, a transmitter (e.g., a UE or a network node) may transmit a TB that includes important control messages in the dedicated CB with a lower code rate, and less important control messages in other CBs with a higher code rate. In some examples, important control messages may be associated with a first priority, and less important control messages may be associated with a second priority lower than the first priority.

In some aspects, the transmitter may provide an indication that the TB contains at least one important control message. For example, the transmitter may indicate that the TB contains the dedicated CB. A receiver (e.g., a network node or UE) may decode the dedicated CB in response to the indication.

Particular aspects of the subject matter described in this disclosure can be implemented to realize one or more of the following potential advantages. In some examples, the described techniques can be used to improve successful transmission rates of important control messages. For example, the lower code rate of the dedicated CB may help to protect important control messages and help to ensure that the important control messages can be decoded successfully. Additionally, or alternatively, the lower code rate of the dedicated CB may allow for earlier successful decoding of the important control messages, which may in turn reduce latency.

In some examples, the indication that the TB contains at least one important control message may help to further ensure that the important control messages can be decoded successfully. For example, a network node that receives the indication may, based at least in part on a presence of the important control messages in the TB, schedule additional HARQ retransmission attempts for the TB. Thus, the network node may successfully decode TBs with important control messages using additional HARQ retransmission attempts. Additionally, or alternatively, the indication may enable the transmitter to avoid including a dedicated CB in every TB, which may help to increase spectral efficiency.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

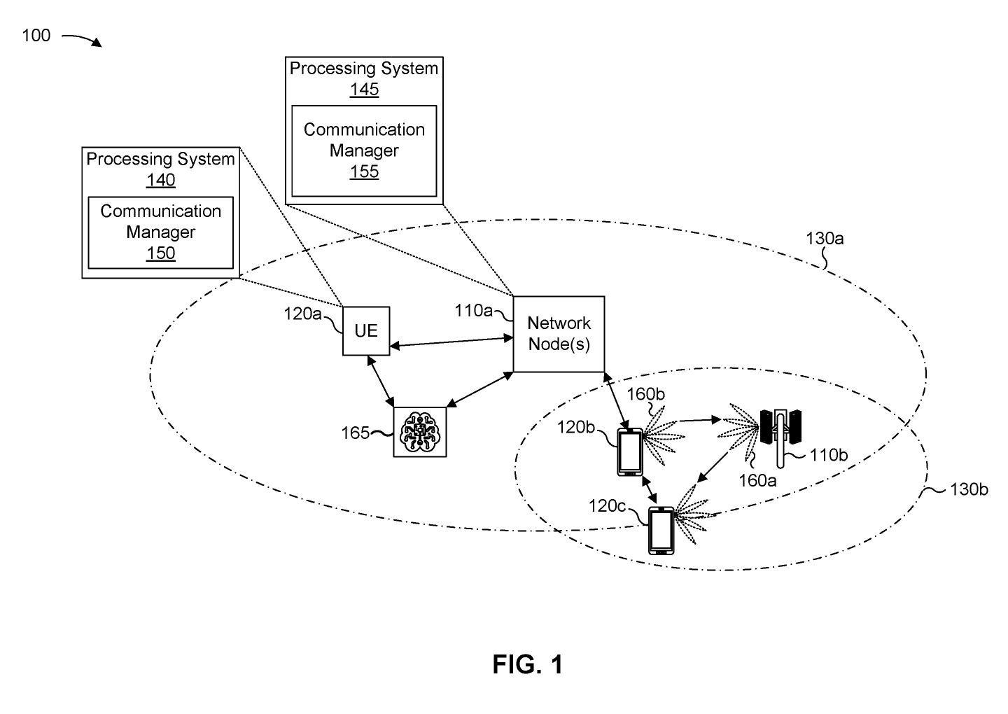

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of an RLC layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 or the network node 110 may include a communication manager 150 or 155, respectively. As described in more detail elsewhere herein, the communication manager 150 or 155 may transmit a first CB of a TB, the first CB associated with a first code rate in accordance with the first CB including one or more first control messages of a first priority level; and transmit a second CB of the TB, the second CB associated with a second code rate that is greater than the first code rate in accordance with the second CB including one or more second control messages of a second priority level that is lower than the first priority level. Additionally, or alternatively, the communication manager 150 or 155 may perform one or more other operations described herein.

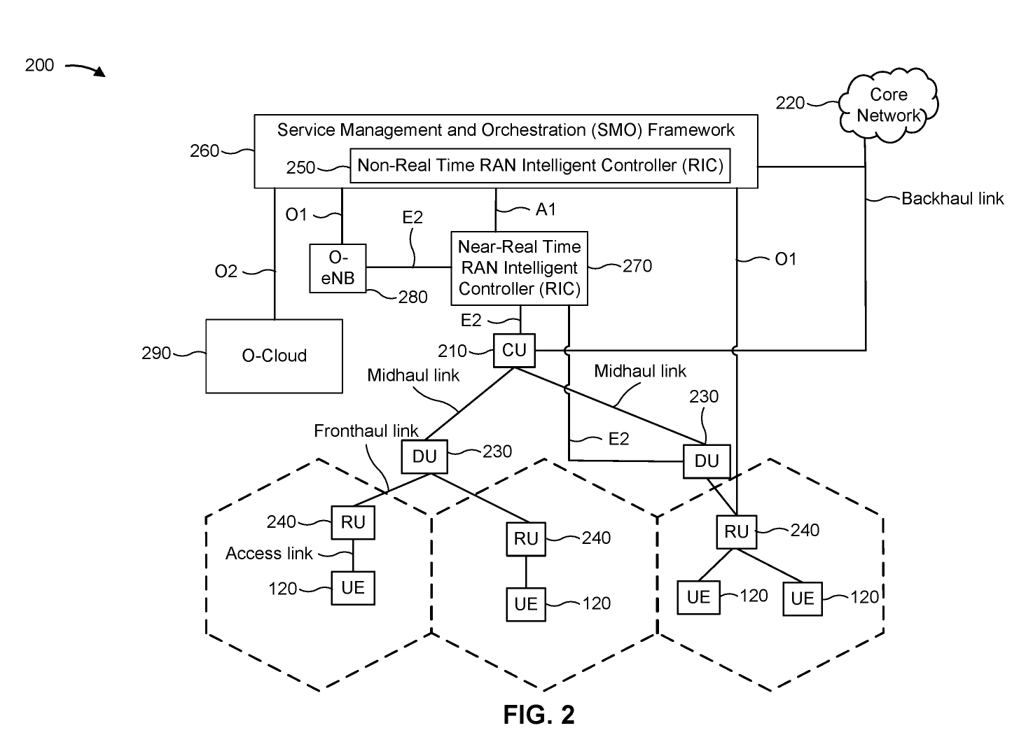

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

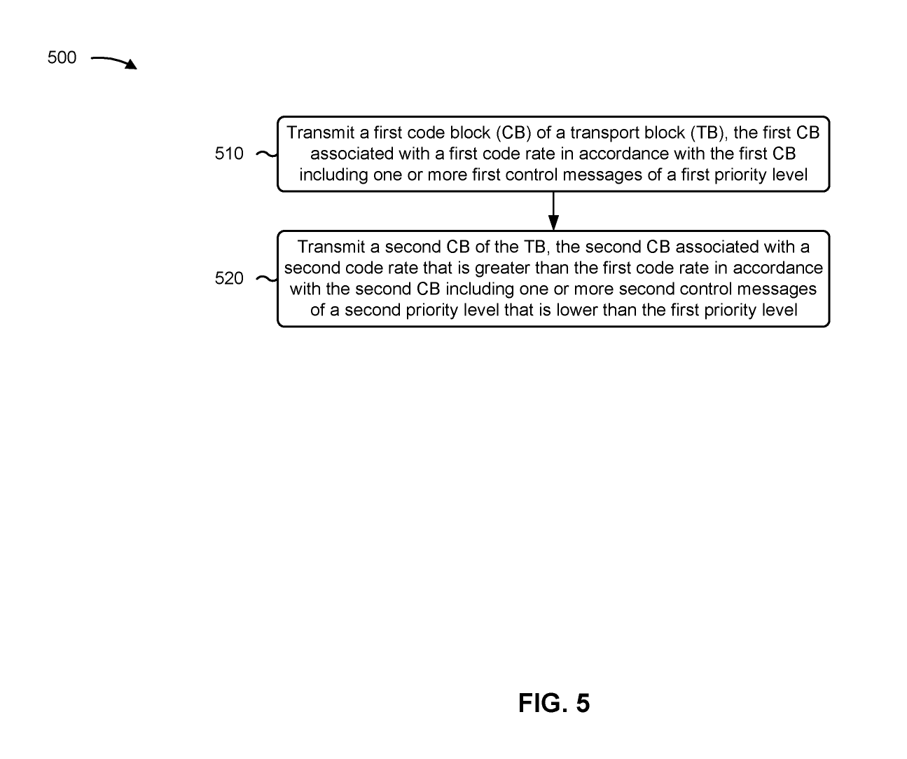

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with code rates of control messages in accordance with priority levels, as described in more detail elsewhere herein. For example, the processing system 145 of the network node 110, the processing system 140 of the UE 120, the CU 210, the DU 230, or the RU 240 may perform or direct operations of, for example, process 500 of FIG. 5 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5 or other processes as described herein. In some examples, executing instructions may include running the instructions, converting the instructions, compiling the instructions, or interpreting the instructions, among other examples. In some aspects, the wireless communication device described herein is the network node 110, is included in the network node 110, or includes one or more components of the network node 110 shown in FIG. 1. In some aspects, the wireless communication device described herein is the UE 120, is included in the UE 120, or includes one or more components of the UE 120 shown in FIG. 1.

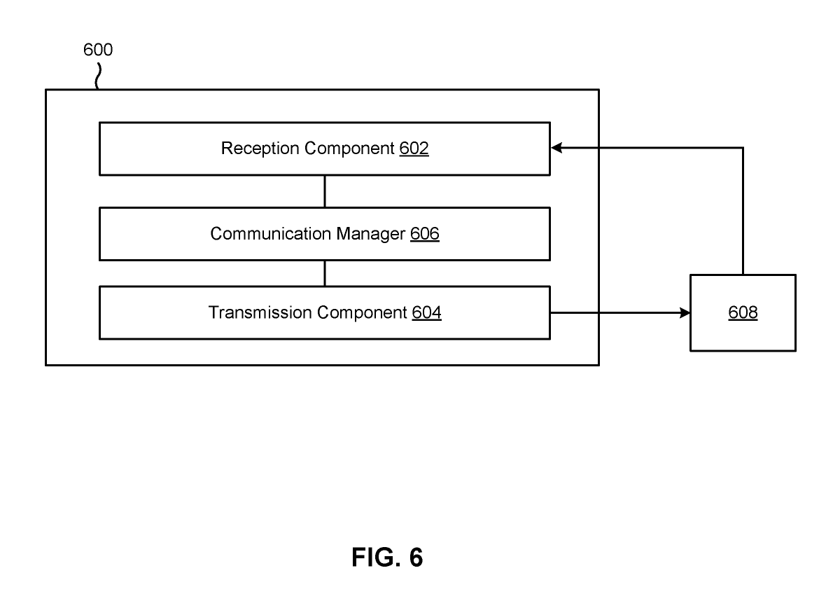

In some aspects, the wireless communication device includes means for transmitting a first CB of a TB, the first CB associated with a first code rate in accordance with the first CB including one or more first control messages of a first priority level; or means for transmitting a second CB of the TB, the second CB associated with a second code rate that is greater than the first code rate in accordance with the second CB including one or more second control messages of a second priority level that is lower than the first priority level. In some aspects, the means for the wireless communication device to perform operations described herein may include, for example, one or more of communication manager 155, processing system 145, communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

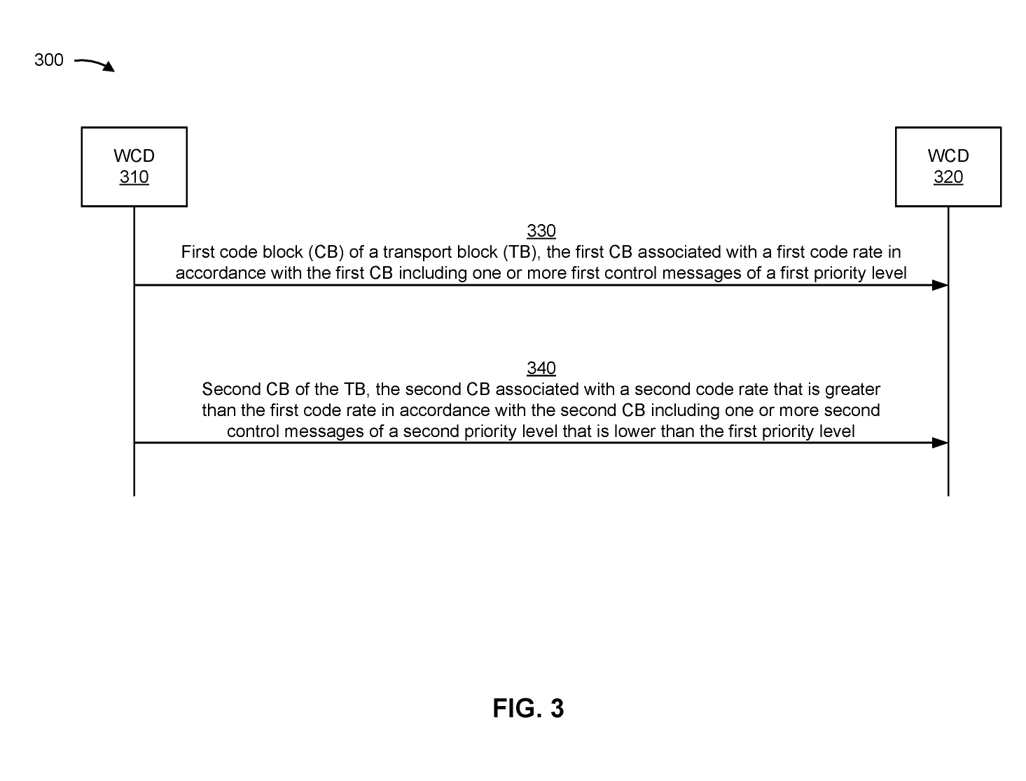

FIG. 3 is a diagram illustrating an example 300 associated with signaling for code rates of control messages in accordance with priority levels. As shown in FIG. 3, a wireless communication device (“WCD”) 310 and a wireless communication device 320 may communicate with one another. In some examples, the wireless communication device 310 may be a network node 110 and the wireless communication device 320 may be a UE 120. In some examples, the wireless communication device 310 may be a UE 120 and the wireless communication device 320 may be a network node 110. In some examples, the wireless communication device 310 may be a UE 120 and the wireless communication device 320 may be another UE 120.

As shown by reference number 330, the wireless communication device 310 may transmit, and the wireless communication device 320 may receive, a first CB of a TB. The TB may be an uplink TB (e.g., in cases where the wireless communication device 310 is a UE 120 and the wireless communication device 320 is a network node 110) or a downlink TB (e.g., in cases where the wireless communication device 310 is a network node 110 and the wireless communication device 320 is a UE 120). In some aspects, the first CB may be associated with a first code rate in accordance with the first CB including one or more first control messages of a first priority level. The first CB may be associated with the first code rate in that the first CB may have (e.g., be transmitted with) the first code rate. In some examples, the first CB may be associated with the first code rate based at least in part on the one or more first control messages in the first CB having the first priority level. The first priority level may indicate that the one or more first control messages have a high importance. For example, the one or more first control messages may include an RLC status report, an indication of unsuccessful HARQ termination, or a MAC-CE, among other examples.

As shown by reference number 340, the wireless communication device 310 may transmit, and the wireless communication device 320 may receive, a second CB of the TB. In some aspects, the second CB may be associated with a second code rate that is greater than the first code rate in accordance with the second CB including one or more second control messages of a second priority level that is lower than the first priority level. The second CB may be associated with the second code rate in that the second CB may have (e.g., be transmitted with) the second code rate. Because the second code rate is greater than the first code rate, the second CB may carry data more efficiently than the first CB, and the first CB may have a higher resiliency than the second CB. In some examples, the second CB may be associated with the second code rate based at least in part on the one or more second control messages in the second CB having the second priority level. The second priority level, being lower than the first priority level, may indicate that the one or more second control messages have a lower importance than the one or more first control messages. For example, the one or more second control messages may include a BSR or a PHR (such as for a UE 120), among other examples. In some examples, the size of the first CB may be identified based at least in part on a back-off code rate with respect to a size of other CBs in the TB that do not carry important control messages, such as the second CB. In some examples, the back-off code rate may be configured via RRC signaling, a downlink grant, an uplink grant, or the like.

In some aspects, the first CB and the second CB may include a same total quantity of resource elements (REs), the first CB may include a first total quantity of information bits, and the second CB may include a second total quantity of information bits that is greater than the first total quantity of information bits. For example, each CB in the TB may have the same quantity of REs, and the first CB may have a smaller quantity of information bits than the second CB has. In some examples, spatially coupled MIMO (SC-MIMO) may enable the first CB and the second CB to include the same total quantity of REs, the first CB to include the first total quantity of information bits, and the second CB to include the second total quantity of information bits.

In some aspects, the first CB and the second CB may include a same total quantity of information bits, the first CB may include a first total quantity of REs, and the second CB may include a second total quantity of REs that is less than the first total quantity of REs. For example, each CB in the TB may have the same quantity of information bits, and the first CB may be allocated with a greater quantity of REs than the second CB is allocated with.

In some aspects, the TB may be an uplink TB, and the first CB may be a final CB of the uplink TB. For example, the first CB may be placed within the uplink TB as the final (e.g., last) CB in the uplink TB. Thus, the one or more first control messages may be placed in the final CB in the uplink TB. For example, instead of placing the one or more first control messages after uplink SCH data bits and before the padding bits, the wireless communication device 310 (e.g., the UE 120) may swap the order of the padding bits and the one or more first control messages, such that the uplink TB contains uplink SCH data bits first, followed by the padding bits, and lastly the one or more first control messages. As a result, the final CB of the uplink TB may not contain the padding bits. In some examples, the UE 120 may add, to the padding bits, a header that indicates where in the uplink TB the padding bits end. Additionally, or alternatively, the UE 120 may insert, in the final CB, a sub-header that indicates where the one or more first control messages start in the uplink TB. For example, the wireless communication device 320 (e.g., the network node 110) may, upon decoding the final CB, use the sub-header to identify where bits of the one or more first control messages start in the final CB. In some examples, a MAC entity of the wireless communication device 310 may be aware of one or more boundaries of one or more of the CBs in the uplink TB (e.g., at least the final CB).

In some examples, the TB may be a downlink TB, and the first CB may be an initial CB of the downlink TB. For example, the first CB may be placed within the uplink TB as the initial CB in the downlink TB. Thus, the one or more first control messages may be placed in the initial CB in the downlink TB. For example, the downlink TB may contain the one or more first control messages first, followed by downlink SCH data bits, and lastly padding bits, which may help to align the downlink TB with the appropriate TBS. As a result, the initial CB of the downlink TB may have the first code rate.

In some aspects, the wireless communication device 310 may transmit, and the wireless communication device 320 may receive, an indication that the TB includes at least one control message of the first priority level. For example, the indication may indicate that the TB includes the one or more first control messages. In some examples, the indication may indicate that the TB includes at least one CB that includes at least one control message of the first priority level. For example, the indication may indicate that the TB includes the first CB.

In some aspects, the TB may be an uplink TB, and the indication may include a DMRS sequence associated with the first priority level. The DMRS sequence may be associated with the first priority level in that a presence of the DMRS sequence may indicate a presence of the at least one control message of the first priority level (such as the one or more first control messages). In some examples, the DMRS sequence and the uplink TB may belong to the same PUSCH.

In some aspects, the DMRS sequence may be a first DMRS sequence, and a second DMRS sequence may be associated with the second priority level. The second DMRS sequence may be associated with the second priority level in that a presence of the second DMRS sequence may indicate a presence of the at least one control message of the second priority level. For example, the wireless communication device 310 (e.g., a UE 120) may use two different DMRS sequences (e.g., the first DMRS sequence and the second DMRS sequence), the first sequence indicating that the uplink TB includes at least one control message of the first priority level, and the second sequence indicating that the uplink TB does not include at least one control message of the first priority level (e.g., the second sequence may indicate that the uplink TB includes only control messages of the second priority level). In multi-level importance examples, the quantity of DMRS sequences may be extended beyond two. In some examples, the wireless communication device 310 may use the same DMRS sequence across multiple HARQ retransmissions of the same uplink TB, which may help to ensure consistency.

In some aspects, the TB may be an uplink TB, and the indication may include UCI that is multiplexed on a PUSCH. For example, the UCI may indicate that the TB includes at least one control message of the first priority level or at least one CB that includes at least one control message of the first priority level. In some examples, the UCI may be encoded separately from the uplink TB. In some examples, a set of beta offset values may be configured for the UCI. In some examples, one bit of the UCI may indicate that the TB includes at least one control message of the first priority level or at least one CB that includes at least one control message of the first priority level (e.g., the UCI may include a single-bit payload). In multi-level importance examples, multiple bits of the UCI may indicate respective priorities of the control messages (e.g., the UCI may include a multi-bit payload).

In some aspects, the UCI may be multiplexed on the PUSCH using puncturing. For example, the UCI may puncture the PUSCH. For example, the UCI may puncture the PUSCH in cases where a small quantity of bits (e.g., one or two bits) of the UCI indicate that the TB includes at least one control message of the first priority level or at least one CB that includes at least one control message of the first priority level

In some aspects, the UCI may be multiplexed on the PUSCH using rate-matching. For example, the PUSCH may rate-match around the UCI. In some examples, the PUSCH may rate-match around the UCI in cases where other UCI is also present (e.g., hybrid automatic repeat request acknowledgment (HARQ-ACK) UCI, CSI part 1 UCI, CSI part 2 UCI, or the like).

In some aspects, the UCI may be encoded separately from other UCI multiplexed on the PUSCH. For example, there may be up to four separate encodings for UCI multiplexing on the PUSCH: a first encoding for the UCI, a second encoding for HARQ-ACK UCI, a third encoding for CSI part 1 UCI, and a fourth encoding for CSI part 2 UCI.

In some aspects, the UCI may be encoded jointly with HARQ-ACK UCI multiplexed on the PUSCH. For example, the UCI may be encoded jointly with HARQ-ACK UCI multiplexed on the PUSCH in cases where HARQ-ACK is present. For example, there may be up to three separate encodings for UCI multiplexing on the PUSCH: a first encoding for the jointly-encoded UCI and HARQ-ACK UCI, a second encoding for CSI part 1 UCI, and a third encoding for CSI part 2 UCI.

In some aspects, a priority level of the UCI may be lower than priority levels of HARQ-ACK UCI, CSI part 1 UCI, and CSI part 2 UCI. For example, a priority level of a UCI may determine whether that UCI is de-prioritized relative to other UCI. For example, if other UCI already includes HARQ-ACK, CSI part 1, and CSI part 2, then the UCI may be dropped; if other UCI does not already include HARQ-ACK, CSI part 1, and CSI part 2, then the UCI may be encoded separately from other UCIs (e.g., the other UCIs may have a maximum of two types). If the UCI is dropped, then the UCI may be multiplexed on a previous or subsequent HARQ retransmission of the same uplink TB.

In some aspects, the UCI is encoded separately from other UCI multiplexed on the PUSCH, and a priority level of the UCI and a priority level of HARQ-ACK UCI are higher than a priority level of CSI part 2 UCI. For example, if HARQ-ACK UCI and CSI part 2 UCI are both present, then the CSI part 2 UCI may be dropped, and the UCI may be encoded separately from other UCIs. In some examples, the CSI part 2 may not be multiplexed on the PUSCH if the HARQ-ACK is present, because if the CSI part 2 is present, then a CSI part 1 is also present, and if a maximum of three encodings is permitted for UCI multiplexing, then CSI part 2 UCI may be dropped to allow the UCI to be multiplexed.

In some aspects, the UCI may be multiplexed on the PUSCH in accordance with the UCI being associated with a plurality of PUSCHs. The UCI may be associated with the plurality of PUSCHs in that a type of the UCI (e.g., a UCI indicating that a TB includes at least one control message of the first priority level or at least one CB that includes at least one control message of the first priority level) may be present in each PUSCH of the plurality of PUSCHs. For example, UCI of this type may be multiplexed on every PUSCH. In some examples, the UCI may be multiplexed on the PUSCH in accordance with the UCI being associated with a plurality of PUSCHs regardless of whether or not a PUSCH DMRS is used to indicate a presence of the at least one control message.

In some aspects, the UCI may be multiplexed on the PUSCH in accordance with one or more of an uplink CC associated with the PUSCH or a HARQ identifier (ID) associated with the PUSCH. The uplink CC or HARQ ID may be associated with the PUSCH in that the UCI may be multiplexed on the PUSCH may be transmitted in the uplink CC or using the HARQ ID. For example, a presence of the UCI multiplexed on the PUSCH may be limited to certain uplink CCs or HARQ IDs. In some examples, the uplink CCs or HARQ IDs to which the UCI is limited may be explicitly configured by the wireless communication device 320 (e.g., the network node 110). In some examples, the indication that a TB includes the at least one control message may be transmitted using only certain uplink grants. In some examples, the UCI may be multiplexed on the PUSCH in accordance with one or more of the uplink CC or the HARQ ID regardless of whether or not a PUSCH DMRS is used to indicate a presence of the at least one control message.

As indicated above, FIG. 3 is provided as an example. Other examples may differ from what is described with respect to FIG. 3.

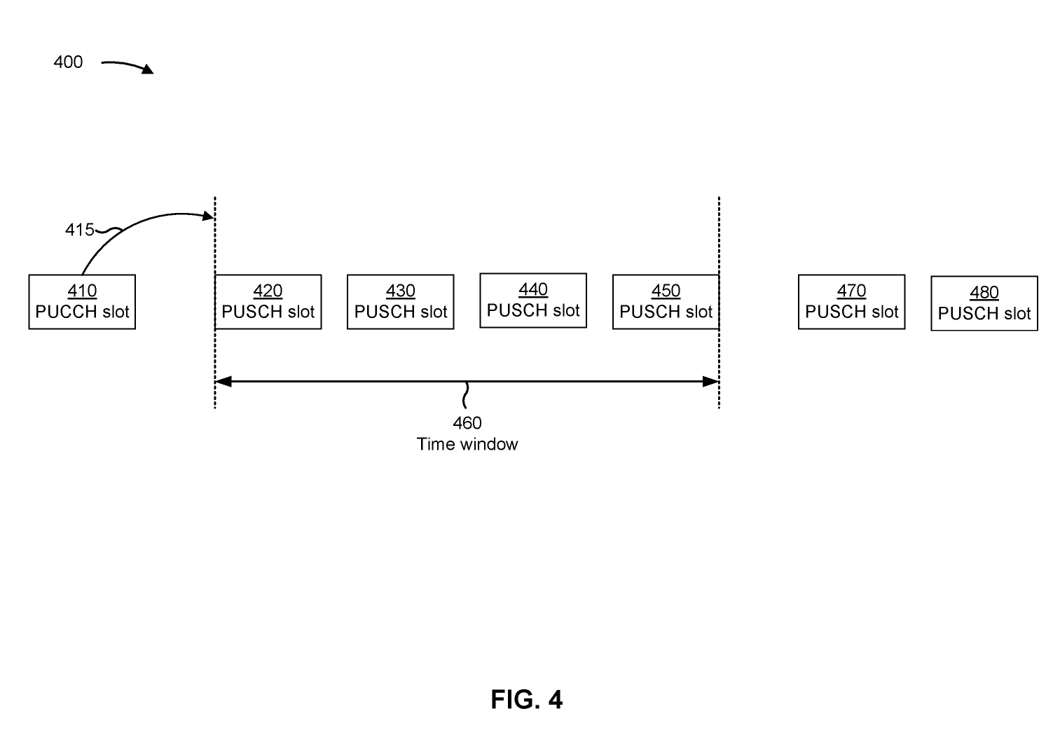

FIG. 4 is a diagram illustrating an example 400 associated with indicating that an uplink TB includes at least one control message of the first priority level using UCI that is multiplexed on a PUSCH.

In some aspects, the TB may be an uplink TB, and the indication may include UCI that is included in a PUCCH and that indicates that a plurality of PUSCH slots in a time window associated with the UCI includes the at least one control message. For example, the UCI may be transmitted via the PUCCH in a PUCCH slot 410 and, as shown by the arrow at 415, may indicate a presence of the at least one control message in one or more of PUSCH slots 420, 430, 440, and 450 (e.g., the UCI in the PUCCH may have a one-to-many mapping with PUSCHs associated with PUSCH slots 420, 430, 440, and 450). The PUSCH slots 420, 430, 440, and 450 may be located in a time window 460. In some examples, the time window 460 may be associated with the UCI in that the UCI may carry an indication regarding the time window 460 (e.g., the UCI may indicate whether or not the time window 460 includes at least one PUSCH slot that carries the at least one control message). In some examples, the time window 460 may be defined (e.g., in terms of a quantity of future PUSCH slots, such as four in example 400) and semi-statically configured (e.g., via RRC signaling). Additionally, or alternatively, an offset (e.g., in terms of a quantity of uplink slots) between the PUCCH slot 410 and a beginning of the time window 460 may be signaled via RRC. As shown, additional PUSCH slots 470 and 480 may occur after the time window 460.

In some aspects, the UCI may include a single bit indicating that the plurality of PUSCH slots includes the at least one control message. For example, the indication of the presence of the at least one control message for each uplink TB of the PUSCH slots 420, 430, 440, and 450 may be bundled. For example, the UCI may include a single-bit indication, where the single bit maps to all of the PUSCH slots 420, 430, 440, and 450. For example, the single bit having a value of 1 may indicate that at least one of PUSCH slots 420, 430, 440, or 450 have the at least one control message in an uplink TB, and the single bit having a value of 0 may indicate that none of the PUSCH slots 420, 430, 440, or 450 have the at least one control message in an uplink TB. For example, if PUSCH slots 420, 430, and 450 have important control messages, and PUSCH slot 440 does not, then a one-bit UCI payload may have a value of 1.

In some aspects, the UCI may include a plurality of bits indicating that respective PUSCH slots of the plurality of PUSCH slots include the at least one control message. For example, the indication of the presence of the at least one control message for an uplink TB of each of the PUSCH slots 420, 430, 440, and 450 may be explicit. For example, the UCI may include a single-bit indication for each PUSCH slot. For example, a bit having a value of 1 may indicate that a corresponding one of the PUSCH slots 420, 430, 440, or 450 have the at least one control message in an uplink TB, and the bit having a value of 0 may indicate that a corresponding one of the PUSCH slots 420, 430, 440, or 450 does not have the at least one control message in an uplink TB. For example, if PUSCH slots 420, 430, and 450 have important control messages, and PUSCH slot 440 does not, then a one-bit UCI payload may have a value of 1. In this example, one bit is allocated for each PUSCH slot, and the payload size of the UCI may depend on a quantity of PUSCH slots in the time window. In example 400, the payload size of the UCI may be four bits because the time window 460 includes a total of four PUSCH slots 420, 430, 440, and 450. For example, if PUSCH slots 420, 430, and 450 have important control messages, and PUSCH slot 440 does not, then the UCI payload may have a value of 1101.

In some aspects, the UCI may include a quantity of bits that is in accordance with one or more of a quantity of the plurality of PUSCH slots or the first priority level. For example, if a multi-bit indication is used to also indicate an importance level of the control messages within each uplink TB, then a payload of the UCI may vary depending on the quantity of PUSCH slots in the time window (e.g., four PUSCH slots in time window 460) and priority level of control messages in each uplink TB. In this example, the UCI payload may carry one or more bits per PUSCH slot in the time window, depending on a total quantity of possible priority levels.

In some aspects, the UCI may be associated with a plurality of uplink CCs or a plurality of HARQ IDs. The UCI may be associated with the plurality of uplink CCs or the plurality of HARQ IDs in that the UCI may be mapped to all uplink CCs or all HARQ IDs. For example, the UCI may be associated with a plurality of uplink CCs or a plurality of HARQ IDs in examples where the PUCCH is on a primary cell (PCell), and multiple PUSCHs are on respective SCells and, thus, may be on multiple CCs. For example, the one-to-many mapping may be based at least in part on the UCI being associated with the plurality of uplink CCs or the plurality of HARQ IDs.

In some aspects, the UCI may be associated with one or more configured uplink CCs or one or more configured HARQ IDs. The UCI may be associated with the one or more configured uplink CCs or the one or more configured HARQ IDs in that the UCI may be mapped to the one or more configured uplink CCs or the one or more configured HARQ IDs. For example, the UCI may be associated with the one or more configured uplink CCs or the one or more configured HARQ IDs in examples where the PUCCH is on a PCell, and multiple PUSCHs are on respective SCells and, thus, may be on multiple CCs. In some examples, the wireless communication device 320 (e.g., the network node 110) may explicitly configure the one or more configured uplink CCs or the one or more configured HARQ IDs. For example, the one-to-many mapping may be based at least in part on the UCI being limited to certain (configured) uplink CCs or HARQ IDs.

As indicated above, FIG. 4 is provided as an example. Other examples may differ from what is described with respect to FIG. 4.

The first CB being associated with the first code rate in accordance with the first CB including one or more first control messages of the first priority level may help to protect the one or more first control messages and help to ensure that the one or more first control messages can be decoded successfully. Additionally, or alternatively, the second code rate being greater than the first code rate may allow for earlier successful decoding of the one or more first control messages, which may in turn reduce latency.

Transmitting the indication that the TB includes at least one control message of the first priority level may help to further ensure that the one or more first control messages can be decoded successfully. For example, the wireless communication device 320 (e.g., a network node 110) may, upon receiving the indication, schedule additional HARQ retransmission attempts for the TB and thereby successfully decode the one or more first control messages. Additionally, or alternatively, the indication may enable the wireless communication device 310 to avoid including a CB associated with the first code rate in every TB, which may help to increase spectral efficiency.

FIG. 5 is a diagram illustrating an example process 500 performed, for example, at a wireless communication device or an apparatus of a wireless communication device. Example process 500 is an example where the apparatus or the wireless communication device (e.g., wireless communication device 310) performs operations associated with code rates of control messages in accordance with priority levels.

As shown in FIG. 5, in some aspects, process 500 may include transmitting a first CB of a TB, the first CB associated with a first code rate in accordance with the first CB including one or more first control messages of a first priority level (block 510). For example, the wireless communication device (e.g., using transmission component 604 or communication manager 606, depicted in FIG. 6) may transmit a first CB of a TB, the first CB associated with a first code rate in accordance with the first CB including one or more first control messages of a first priority level, as described above. In some aspects, the transmission of the first CB may be performed in a manner described above in connection with reference number 330 of FIG. 3.

As further shown in FIG. 5, in some aspects, process 500 may include transmitting a second CB of the TB, the second CB associated with a second code rate that is greater than the first code rate in accordance with the second CB including one or more second control messages of a second priority level that is lower than the first priority level (block 520). For example, the wireless communication device (e.g., using transmission component 604 or communication manager 606, depicted in FIG. 6) may transmit a second CB of the TB, the second CB associated with a second code rate that is greater than the first code rate in accordance with the second CB including one or more second control messages of a second priority level that is lower than the first priority level, as described above. In some aspects, the transmission of the second CB may be performed in a manner described above in connection with reference number 340 of FIG. 3.

Process 500 may include additional aspects, such as any single aspect or any combination of aspects described below or in connection with one or more other processes described elsewhere herein.

In a first aspect, the first CB and the second CB include a same total quantity of REs, the first CB includes a first total quantity of information bits, and the second CB includes a second total quantity of information bits that is greater than the first total quantity of information bits, e.g., as described in connection with FIG. 3.

In a second aspect, alone or in combination with the first aspect, the first CB and the second CB include a same total quantity of information bits, the first CB includes a first total quantity of REs, and the second CB includes a second total quantity of REs that is less than the first total quantity of REs, e.g., as described in connection with FIG. 3.

In a third aspect, alone or in combination with one or more of the first and second aspects, the TB is an uplink TB, and the first CB is a final CB of the uplink TB.

In a fourth aspect, alone or in combination with one or more of the first through third aspects, process 500 includes transmitting an indication that the TB includes at least one control message of the first priority level, e.g., as described in connection with FIG. 3.

In a fifth aspect, alone or in combination with one or more of the first through fourth aspects, the TB is an uplink TB, and the indication comprises a DMRS sequence associated with the first priority level, e.g., as described in connection with FIG. 3.

In a sixth aspect, alone or in combination with one or more of the first through fifth aspects, the DMRS sequence is a first DMRS sequence, and a second DMRS sequence is associated with the second priority level, e.g., as described in connection with FIG. 3.

In a seventh aspect, alone or in combination with one or more of the first through sixth aspects, the TB is an uplink TB, and the indication comprises UCI that is multiplexed on a PUSCH , e.g., as described in connection with FIG. 3.

In an eighth aspect, alone or in combination with one or more of the first through seventh aspects, the UCI is multiplexed on the PUSCH using puncturing, e.g., as described in connection with FIG. 3.

In a ninth aspect, alone or in combination with one or more of the first through eighth aspects, the UCI is multiplexed on the PUSCH using rate-matching, e.g., as described in connection with FIG. 3.

In a tenth aspect, alone or in combination with one or more of the first through ninth aspects, the UCI is encoded separately from other UCI multiplexed on the PUSCH, e.g., as described in connection with FIG. 3.

In an eleventh aspect, alone or in combination with one or more of the first through tenth aspects, the UCI is encoded jointly with HARQ-ACK UCI multiplexed on the PUSCH, e.g., as described in connection with FIG. 3.

In a twelfth aspect, alone or in combination with one or more of the first through eleventh aspects, a priority level of the UCI is lower than priority levels of HARQ-ACK UCI, CSI part 1 UCI, and CSI part 2 UCI, e.g., as described in connection with FIG. 3.

In a thirteenth aspect, alone or in combination with one or more of the first through twelfth aspects, the UCI is encoded separately from other UCI multiplexed on the PUSCH, and a priority level of the UCI and a priority level of HARQ-ACK UCI are higher than a priority level of CSI part 2 UCI, e.g., as described in connection with FIG. 3.

In a fourteenth aspect, alone or in combination with one or more of the first through thirteenth aspects, the UCI is multiplexed on the PUSCH in accordance with the UCI being associated with a plurality of PUSCHs, e.g., as described in connection with FIG. 3.

In a fifteenth aspect, alone or in combination with one or more of the first through fourteenth aspects, the UCI is multiplexed on the PUSCH in accordance with one or more of an uplink CC associated with the PUSCH or a HARQ ID associated with the PUSCH, e.g., as described in connection with FIG. 3.

In a sixteenth aspect, alone or in combination with one or more of the first through fifteenth aspects, the TB is an uplink TB, and the indication comprises UCI that is included in a PUCCH and that indicates that a plurality of PUSCH slots in a time window associated with the UCI includes the at least one control message, e.g., as described in connection with FIG. 4.

In a seventeenth aspect, alone or in combination with one or more of the first through sixteenth aspects, the UCI includes a single bit indicating that the plurality of PUSCH slots includes the at least one control message, e.g., as described in connection with FIG. 4.

In an eighteenth aspect, alone or in combination with one or more of the first through seventeenth aspects, the UCI includes a plurality of bits indicating that respective PUSCH slots of the plurality of PUSCH slots include the at least one control message, e.g., as described in connection with FIG. 4.

In a nineteenth aspect, alone or in combination with one or more of the first through eighteenth aspects, the UCI includes a quantity of bits that is in accordance with one or more of a quantity of the plurality of PUSCH slots or the first priority level, e.g., as described in connection with FIG. 4.

In a twentieth aspect, alone or in combination with one or more of the first through nineteenth aspects, the UCI is associated with a plurality of uplink CCs or a plurality of HARQ IDs, e.g., as described in connection with FIG. 4.

In a twenty-first aspect, alone or in combination with one or more of the first through twentieth aspects, the UCI is associated with one or more configured uplink CCs or one or more configured HARQ IDs, e.g., as described in connection with FIG. 4.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a wireless communication device, or a wireless communication device may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 or 155 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 or 145 described in connection with FIG. 1) of the wireless communication device.

In some aspects, the apparatus 600 may be configured to perform one or more operations described herein in connection with FIGS. 3-4. Additionally, or alternatively, the apparatus 600 may be configured to perform one or more processes described herein, such as process 500 of FIG. 5. In some aspects, the apparatus 600 or one or more components shown in FIG. 6 may include one or more components of the wireless communication device described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the wireless communication device described above in connection with FIG. 1, such as a radio, one or more RF chains, one or more transceivers, or one or more modems, each of which may in turn be coupled with one or more antennas of the wireless communication device described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The transmission component 604 may transmit a first CB of a TB, the first CB associated with a first code rate in accordance with the first CB including one or more first control messages of a first priority level. The transmission component 604 may transmit a second CB of the TB, the second CB associated with a second code rate that is greater than the first code rate in accordance with the second CB including one or more second control messages of a second priority level that is lower than the first priority level. In some aspects, the transmission component 604 may transmit an indication that the TB includes at least one control message of the first priority level.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a wireless communication device, comprising: transmitting a first code block (CB) of a transport block (TB), the first CB associated with a first code rate in accordance with the first CB including one or more first control messages of a first priority level; and transmitting a second CB of the TB, the second CB associated with a second code rate that is greater than the first code rate in accordance with the second CB including one or more second control messages of a second priority level that is lower than the first priority level.

Aspect 2: The method of Aspect 1, wherein the first CB and the second CB include a same total quantity of resource elements (REs), the first CB includes a first total quantity of information bits, and the second CB includes a second total quantity of information bits that is greater than the first total quantity of information bits.

Aspect 3: The method of any of Aspects 1-2, wherein the first CB and the second CB include a same total quantity of information bits, the first CB includes a first total quantity of resource elements (REs), and the second CB includes a second total quantity of REs that is less than the first total quantity of REs.

Aspect 4: The method of any of Aspects 1-3, wherein the TB is an uplink TB, and the first CB is a final CB of the uplink TB.

Aspect 5: The method of any of Aspects 1-4, further comprising: transmitting an indication that the TB includes at least one control message of the first priority level.

Aspect 6: The method of Aspect 5, wherein the TB is an uplink TB, and the indication comprises a demodulation reference signal (DMRS) sequence associated with the first priority level.

Aspect 7: The method of Aspect 6, wherein the DMRS sequence is a first DMRS sequence, and wherein a second DMRS sequence is associated with the second priority level.

Aspect 8: The method of Aspect 5, wherein the TB is an uplink TB, and the indication comprises uplink control information (UCI) that is multiplexed on a physical uplink shared channel (PUSCH).

Aspect 9: The method of Aspect 8, wherein the UCI is multiplexed on the PUSCH using puncturing.

Aspect 10: The method of Aspect 8, wherein the UCI is multiplexed on the PUSCH using rate-matching.

Aspect 11: The method of Aspect 8, wherein the UCI is encoded separately from other UCI multiplexed on the PUSCH.

Aspect 12: The method of Aspect 8, wherein the UCI is encoded jointly with hybrid automatic repeat request acknowledgment (HARQ-ACK) UCI multiplexed on the PUSCH.

Aspect 13: The method of Aspect 8, wherein a priority level of the UCI is lower than priority levels of hybrid automatic repeat request acknowledgment (HARQ-ACK) UCI, channel state information (CSI) part 1 UCI, and CSI part 2 UCI.

Aspect 14: The method of Aspect 8, wherein the UCI is encoded separately from other UCI multiplexed on the PUSCH, and a priority level of the UCI and a priority level of hybrid automatic repeat request acknowledgment (HARQ-ACK) UCI are higher than a priority level of channel state information (CSI) part 2 UCI.

Aspect 15: The method of Aspect 8, wherein the UCI is multiplexed on the PUSCH in accordance with the UCI being associated with a plurality of PUSCHs.

Aspect 16: The method of Aspect 8, wherein the UCI is multiplexed on the PUSCH in accordance with one or more of an uplink component carrier (CC) associated with the PUSCH or a hybrid automatic repeat request (HARQ) identifier (ID) associated with the PUSCH.

Aspect 17: The method of Aspect 5, wherein the TB is an uplink TB, and the indication comprises uplink control information (UCI) that is included in a physical uplink control channel (PUCCH) and that indicates that a plurality of physical uplink shared channel (PUSCH) slots in a time window associated with the UCI includes the at least one control message.

Aspect 18: The method of Aspect 17, wherein the UCI includes a single bit indicating that the plurality of PUSCH slots includes the at least one control message.

Aspect 19: The method of Aspect 17, wherein the UCI includes a plurality of bits indicating that respective PUSCH slots of the plurality of PUSCH slots include the at least one control message.

Aspect 20: The method of Aspect 17, wherein the UCI includes a quantity of bits that is in accordance with one or more of a quantity of the plurality of PUSCH slots or the first priority level.

Aspect 21: The method of Aspect 17, wherein the UCI is associated with a plurality of uplink component carriers (CCs) or a plurality of hybrid automatic repeat request (HARQ) identifiers (IDs).

Aspect 22: The method of Aspect 17, wherein the UCI is associated with one or more configured uplink component carriers (CCs) or one or more configured hybrid automatic repeat request (HARQ) identifiers (IDs).

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories; and
one or more processors coupled to the one or more memories, the one or more processors individually or collectively configured to:
transmit a first code block (CB) of a transport block (TB), the first CB associated with a first code rate in accordance with the first CB including one or more first control messages of a first priority level; and
transmit a second CB of the TB, the second CB associated with a second code rate that is greater than the first code rate in accordance with the second CB including one or more second control messages of a second priority level that is lower than the first priority level.

2. The apparatus of claim 1, wherein the first CB and the second CB include a same total quantity of resource elements (REs), the first CB includes a first total quantity of information bits, and the second CB includes a second total quantity of information bits that is greater than the first total quantity of information bits.

3. The apparatus of claim 1, wherein the first CB and the second CB include a same total quantity of information bits, the first CB includes a first total quantity of resource elements (REs), and the second CB includes a second total quantity of REs that is less than the first total quantity of REs.

4. The apparatus of claim 1, wherein the TB is an uplink TB, and the first CB is a final CB of the uplink TB.

5. The apparatus of claim 1, wherein the one or more processors are individually or collectively configured to:
transmit an indication that the TB includes at least one control message of the first priority level.

6. The apparatus of claim 5, wherein the TB is an uplink TB, and the indication comprises a demodulation reference signal (DMRS) sequence associated with the first priority level.

7. The apparatus of claim 6, wherein the DMRS sequence is a first DMRS sequence, and wherein a second DMRS sequence is associated with the second priority level.

8. The apparatus of claim 5, wherein the TB is an uplink TB, and the indication comprises uplink control information (UCI) that is multiplexed on a physical uplink shared channel (PUSCH).

9. The apparatus of claim 8, wherein the UCI is multiplexed on the PUSCH using puncturing.

10. The apparatus of claim 8, wherein the UCI is multiplexed on the PUSCH using rate-matching.

11. The apparatus of claim 8, wherein the UCI is encoded separately from other UCI multiplexed on the PUSCH.

12. The apparatus of claim 8, wherein the UCI is encoded jointly with hybrid automatic repeat request acknowledgment (HARQ-ACK) UCI multiplexed on the PUSCH.

13. The apparatus of claim 8, wherein a priority level of the UCI is lower than priority levels of hybrid automatic repeat request acknowledgment (HARQ-ACK) UCI, channel state information (CSI) part 1 UCI, and CSI part 2 UCI.

14. The apparatus of claim 8, wherein the UCI is encoded separately from other UCI multiplexed on the PUSCH, and a priority level of the UCI and a priority level of hybrid automatic repeat request acknowledgment (HARQ-ACK) UCI are higher than a priority level of channel state information (CSI) part 2 UCI.

15. The apparatus of claim 8, wherein the UCI is multiplexed on the PUSCH in accordance with the UCI being associated with a plurality of PUSCHs.

16. The apparatus of claim 8, wherein the UCI is multiplexed on the PUSCH in accordance with one or more of an uplink component carrier (CC) associated with the PUSCH or a hybrid automatic repeat request (HARQ) identifier (ID) associated with the PUSCH.

17. The apparatus of claim 5, wherein the TB is an uplink TB, and the indication comprises uplink control information (UCI) that is included in a physical uplink control channel (PUCCH) and that indicates that a plurality of physical uplink shared channel (PUSCH) slots in a time window associated with the UCI includes the at least one control message.

18. The apparatus of claim 17, wherein the UCI includes a single bit indicating that the plurality of PUSCH slots includes the at least one control message.

19. The apparatus of claim 17, wherein the UCI includes a plurality of bits indicating that respective PUSCH slots of the plurality of PUSCH slots include the at least one control message.

20. The apparatus of claim 17, wherein the UCI includes a quantity of bits that is in accordance with one or more of a quantity of the plurality of PUSCH slots or the first priority level.

21. The apparatus of claim 17, wherein the UCI is associated with a plurality of uplink component carriers (CCs) or a plurality of hybrid automatic repeat request (HARQ) identifiers (IDs).

22. The apparatus of claim 17, wherein the UCI is associated with one or more configured uplink component carriers (CCs) or one or more configured hybrid automatic repeat request (HARQ) identifiers (IDs).

23. A method of wireless communication performed by a wireless communication device, comprising:
transmitting a first code block (CB) of a transport block (TB), the first CB associated with a first code rate in accordance with the first CB including one or more first control messages of a first priority level; and
transmitting a second CB of the TB, the second CB associated with a second code rate that is greater than the first code rate in accordance with the second CB including one or more second control messages of a second priority level that is lower than the first priority level.

24. The method of claim 23, wherein the first CB and the second CB include a same total quantity of resource elements (REs), the first CB includes a first total quantity of information bits, and the second CB includes a second total quantity of information bits that is greater than the first total quantity of information bits.

25. The method of claim 23, wherein the first CB and the second CB include a same total quantity of information bits, the first CB includes a first total quantity of resource elements (REs), and the second CB includes a second total quantity of REs that is less than the first total quantity of REs.

26. The method of claim 23, wherein the TB is an uplink TB, and the first CB is a final CB of the uplink TB.

27. The method of claim 23, further comprising:
transmitting an indication that the TB includes at least one control message of the first priority level.

28. The method of claim 27, wherein the TB is an uplink TB, and the indication comprises a demodulation reference signal (DMRS) sequence associated with the first priority level.

29. An apparatus for wireless communication, comprising:
means for transmitting a first code block (CB) of a transport block (TB), the first CB associated with a first code rate in accordance with the first CB including one or more first control messages of a first priority level; and
means for transmitting a second CB of the TB, the second CB associated with a second code rate that is greater than the first code rate in accordance with the second CB including one or more second control messages of a second priority level that is lower than the first priority level.

30. A non-transitory computer-readable medium storing a set of instructions for wireless communication, the set of instructions comprising:
one or more instructions that, when executed by one or more processors of a wireless communication device, cause the wireless communication device to:
transmit a first code block (CB) of a transport block (TB), the first CB associated with a first code rate in accordance with the first CB including one or more first control messages of a first priority level; and
transmit a second CB of the TB, the second CB associated with a second code rate that is greater than the first code rate in accordance with the second CB including one or more second control messages of a second priority level that is lower than the first priority level.
